(19) United States
(12) Patent Application Publication
(10) Pub. No.: US 2012/0304942 A1
(43) Pub. Date: Dec. 6, 2012

(54) Apparatus for Coupling a Pet Leash and a Pet Collar

(76) Inventor: Ronald Louro, Warren, RI (US)

(21) Appl. No.: 13/152,029

(22) Filed: Jun. 2, 2011

(51) Int. Cl. A01K 27/00

(52) U.S. Cl. 119/792

(57) ABSTRACT

An apparatus that couples an animal leash and animal collar to form a harness assembly. The apparatus is placed on the back of an animal and contains two separate channels configured to hold and maintain a flat leash in a loop encircling the animal's torso. The elongate and narrow shape of the channels prevents the contained leash from turning or becoming tangled in the around the animal. The apparatus is detachable into two separate components to allow the loop to be removable from the animal. The apparatus also contains a snap bolt connecter for attaching the collar.

### FIELD OF THE INVENTION

The field of the invention relates to an apparatus for easily attaching and maintaining a standard flat leash around the torso of an animal in a loop. The apparatus also contains a bolt snap or other connector for attaching the looped leash to the animal collar. The apparatus is allows the looped leash to be easily detachable from the animal by unlocking into two separate portions.

### BACKGROUND OF INVENTION

Domesticated household animals, such as dogs, cats or other pets, are restrained and controlled by a leash held by a user. However, since conventional leashes are only connected to a neck collar, these connections may not provide enough control over the animal. The collar may be loosely fitted around the animal, the animal may be more aggressive in nature, or act more aggressive when exposed to various stimuli, such as other nearby animals or loud noises. Furthermore, conventional leashes and collars may choke or otherwise apply undesirable forces to a neck of the animal.

Various harnesses have been developed that can be attached over an animal. These body harnesses provide an owner with greater control when attached to a leash since the harness is often connected around the neck and torso of the animal.

However, such harnesses can be cumbersome to attach to animals, especially animals that are prone to a lot of movement.

The subject invention solves the problem of the prior art by providing a device that can be used with existing strap leashes and collars to easily form and maintain a stable animal harness. This invention allows an owner to easily attach and remove this harness assembly to an animal with a few simple movements.

### SUMMARY OF THE INVENTION

There are additional features of the invention that will be described hereinafter and which will form the subject matter of the claims appended hereto. In this respect, before explaining at least one embodiment of the invention in detail, it is to be understood that the invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of the description and should not be regarded as limiting.

The subject invention discloses an animal restraining apparatus for removably coupling an animal leash and an animal collar; the apparatus comprising: a housing comprising a central axis defined by a first portion removably attached to a second portion, and further defined by a first side and a second side, wherein the first side and the second side are separated by a boundary component; a first connector extending along a first axis from a proximal end attached to the housing to a distal end, wherein the first axis is substantially perpendicular to the central axis; wherein the apparatus is mounted on the back of the animal such that the distal end of the first connector is proximate to the neck of the animal, further wherein a distal end of the leash is inserted through a first channel traversing the first portion of the housing, wrapped onto the abdomen of the animal, inserted through a second channel traversing the second portion of the housing, and re-attached to a non-distal end portion of the animal leash to define a loop encircling the torso of the animal, wherein the distal end of the first connector removably attaches to a second connector mounted on the animal collar; and a user-actuated release mechanism on the housing that separates the first portion of the housing from the second portion of the housing for removing the looped leash from the animal.

In further embodiments of the subject invention, the housing may have a shape that is substantially cylindrical, spherical, cube, cuboid, hexagonal prism, or octagonal prism.

In another embodiment of the subject invention, the housing may have a cross-sectional shape traverse to the central axis that is selected from the group consisting of substantially circular, elliptical, square, triangular, hexagonal or octagonal.

In an additional embodiment of the subject invention, the first connection may be a bolt snap.

In another embodiment of the subject invention, the second connector on collar may be a ring secured thereto.

In a further embodiment of the subject invention, the leash may be a wide flat leash.

In an additional embodiment of the subject invention, the leash may be a strap lease.

In another embodiment of the subject invention, the leash may be composed of non-metallic materials.

In a further embodiment of the subject invention, the user actuated release mechanism may be a movable latch on the first portion configured to lock into a latching hole on the second portion.

In an additional embodiment of the subject invention, the latch may be a spring-action release button.

In a further embodiment of the subject invention, the first channel and the second channel may complementary shapes with each other.

In another embodiment of the subject invention, the first channel and the second channel may have non-complementary shapes.

In an additional embodiment of the subject invention, the first channel and the second channel may be substantially parallel with the boundary component of the housing.

In another embodiment of the subject invention, the first channel and the second channel may each be configured to hold the leash such that the leash cannot turn in the apparatus.

In a further embodiment of the subject invention, the first channel and the second channel may each be configured to slidably receive the animal leash such that a wide flat surface of the animal leash remains substantially aligned with the central axis as it is inserted.

In an additional embodiment of the subject invention, the first channel and the second channel may each have an elongated narrow shape.

In another embodiment of the subject invention, the boundary component may have an exterior surface that is substantially parallel with the central axis.

In a further embodiment of the subject invention, the first side and the second side of the housing may be substantially flat.

In an additional embodiment of the subject invention, the first side and the second side of the housing may be substantially coplanar.

In further embodiments of the subject invention, the first side and the second side of the housing may be substantially perpendicular to the central axis.

Another embodiment of the subject invention is a control device for use with small quadruped animals having a pair of forelegs that releasably couples an animal leash and an animal collar mounted around the neck of the animal; the apparatus comprising: a housing comprising a substantially flattened shape with a central axis, defined by a first portion removably attached to a second portion in a locked configuration, and further defined by a first side and a second side; a first channel traversing the first portion of the housing, wherein the first channel is configured to slidably receive the animal leash; a second channel traversing the second portion of the housing, wherein the second channel is configured to slidably receive the animal leash; a first connector extending along a first axis from a proximal end to a distal end, wherein the first connector is attached to housing at the proximal end and the first axis is substantially perpendicular to the central axis; wherein the apparatus is mounted on the back of the animal such that the distal end of the first connector is proximate to the neck of the animal, wherein the animal leash is inserted though the first channel, mounted underneath the animal behind the pair of forelegs, inserted through the second channel and re-attached to a non-distal end portion of the animal leash to define a loop encircling the torso of an animal, further wherein the distal end of the first connector removably couples to a second connector mounted on the animal collar; and a user-actuated mechanism on the housing that separates the first portion of the housing from the second portion of the housing in an unlocked configuration for removing the looped leash from the animal.

Another embodiment of the subject invention is an animal restraining harness assembly comprising: a collar mounted on the neck of the animal with a attached ring; a detachable coupling apparatus comprising a substantially disk shaped housing with a central axis, wherein the housing is defined by a first portion removably attached to a second portion, and the housing is further defined by a first side and a second side, wherein the first side and the second side are separated by a boundary component; a bolt snap attached at a proximal end to the housing and extending along a first axis that is substantially perpendicular to the central axis to a distal end, wherein the apparatus is placed on the back of the animal such that the distal end of the bolt snap is removably attached to the attached ring on the collar; a wide flat animal leash inserted through a first channel traversing the first portion of the housing, wherein the first channel is configured to receive the animal leash such that the wide flat surface of the animal leash remains substantially aligned with the central axis as it passes through the first channel, wherein the leash is wrapped underneath the body of the animal, further wherein the leash is inserted through a second channel traversing the second portion of the housing, wherein the second channel is configured to receive the animal leash such that the widest flat surface of the animal leash remains substantially aligned with the central axis as it passes through the second channel, and the leash is attached to a non-distal end portion to define a loop encircling the torso of the animal; and a user-actuated release mechanism on the housing that separates the first portion of the housing from the second portion of the housing for removing the looped leash from the animal.

Another embodiment of the subject invention is an animal restraining apparatus for removably coupling a wide flat animal leash and an animal collar to form an animal harness; the apparatus comprising: a housing comprising a substantially disk shape with a central axis, defined by a first portion removably attached to a second portion, and further defined by a substantially flat first side and a substantially flat second side, wherein the first side and the second side are substantially perpendicular to the central axis, and the housing is further defined by a substantially curved boundary component separating the first side and the second side; a first channel traversing the first portion of the housing from a first opening on the first side to a second opening on the second side, wherein the first channel is configured to receive the animal leash; a second channel traversing the second portion of the housing from a third opening on the first side to a fourth opening on the second side, wherein the second channel is configured to receive the animal leash; a bolt snap extending along a first axis from a proximal end to a distal end, wherein the bolt snap is attached to the housing at the proximal end and the first axis is substantially perpendicular to the central axis; wherein the apparatus is mounted on the back of the animal such that the distal end of the bolt snap is proximate to the neck of the animal, further wherein a distal end of the animal leash is inserted though the first channel, wrapped underneath the animal behind the forelegs, inserted through the second channel and re-attached to a non-distal end portion of the animal leash to form a loop encircling the torso of the animal; wherein the distal end of the bolt snap removably attaches to the animal collar to form the animal harness with the looped leash; and a user-actuated release mechanism on the housing that separates the first portion of the housing from the second portion of the housing for removing the looped leash from the animal.

Another embodiment of the subject invention is an animal restraining apparatus for removably coupling a wide flat animal leash and an animal collar to form an animal harness, the apparatus comprising: a housing comprising a substantially cylindrical shape with a cylindrical axis, defined by a first portion removably attached to a second portion, and further defined by a substantially flat first side and a substantially flat second side, wherein the first side and the second side are substantially coplanar and perpendicular to the cylindrical axis, and the housing is further defined by a substantially curved boundary component separating the first side and the second side, wherein the curved boundary component has an exterior surface that is substantially parallel with the cylindrical axis; a first channel traversing the first portion of the housing from a first opening on the first side to a second opening on the second side, wherein the first channel is substantially parallel with the curved boundary component, further wherein the first channel is configured to slidably receive the animal leash such that the wide flat surface of the animal leash remains substantially aligned with the cylindrical axis as it is inserted through the first channel; a second channel traversing the second portion of the housing from a third opening on the first side to a fourth opening on the second side, wherein the second channel is substantially parallel with the curved boundary component, further wherein the second channel is configured to slidably receive the animal leash such that the wide flat surface of the animal leash remains substantially aligned with the cylindrical axis as it is inserted through the second channel, wherein the first channel and the second channel comprises complementary shapes on the housing; a bolt snap extending along a first axis from a proximal end to a distal end, wherein the bolt snap is attached to the housing at the proximal end and the first axis is substantially perpendicular to the cylindrical axis; wherein the apparatus is placed on the back of the animal such that the distal end of the bolt snap is proximate to the neck of the animal, further wherein a distal end of the animal leash is inserted though the first channel, wrapped underneath the body of the animal, inserted through the second channel and re-attached to a non-distal end portion of the animal leash to form a loop encircling the animal, wherein the distal end of the bolt snap removably attaches to the animal collar to form the animal harness with the looped leash; and a user-actuated release mechanism on the housing that separates the first portion of the housing from the second portion of the housing for removing the looped animal leash from the animal.

There have thus been broadly outlined important features of the invention in order that the detailed description thereof that follows may be better understood, and in order that the present contribution to the art may be better appreciated. There are additional features of the invention that will be described hereinafter and which will form the subject matter of the claims appended hereto. These together with other embodiments of the invention, and with various features of novelty which characterize the invention, are pointed out with particularity in the claims annexed to and formed as part of this disclosure.

For a conceptual understanding of the invention and its operational advantages, refer to the accompanying drawings and descriptive matter in which there are preferred embodiments of the invention illustrated. Other features and advantages of the present invention will become apparent from the following description of the preferred embodiment(s), taken in conjunction with the accompanying drawings, which by way of example; illustrate the principles of the invention.

### BRIEF DESCRIPTION OF THE DRAWINGS

Advantages of the present invention will be apparent from the following detailed description of exemplary embodiments thereof, which description should be considered in conjunction with the accompanying drawings:

FIG. 1 illustrates an isometric view of one embodiment of the apparatus for coupling a pet leash and a pet collar.

FIG. 2 illustrates a right side view of one embodiment of the apparatus for coupling a pet leash and a pet collar.

FIG. 3 illustrates a left side view of one embodiment of the apparatus for coupling a pet leash and a pet collar.

FIG. 4 illustrates a back view of one embodiment of the apparatus for coupling a pet leash and a pet collar.

FIG. 5 illustrates a front view of another embodiment of the apparatus for coupling a pet leash and a pet collar.

FIG. 6 illustrates a side view of another embodiment of the apparatus for coupling a pet leash and a pet collar.

FIG. 7 illustrates an isometric view of another embodiment of the apparatus for coupling a pet leash and a pet collar.

FIG. 8 illustrates a bottom view of another embodiment of the apparatus for coupling a pet leash and a pet collar.

FIG. 9 illustrates an isometric view of the one embodiment of the apparatus coupling a pet leash and a pet collar in the closed position.

FIG. 10 illustrates an isometric view of one embodiment of the apparatus coupling a pet leash in the open position.

FIG. 11 illustrates an isometric view of the one embodiment of the apparatus coupling a pet leash and a pet collar around a pet.

### DETAILED DESCRIPTION OF EMBODIMENTS

The following will describe, in detail, several embodiments of the present invention. These embodiments are provided by way of explanation only, and thus, should not unduly restrict the scope of the invention. In fact, those of ordinary skill in the art will appreciate upon reading the present specification and viewing the present drawings that the invention teaches many variations and modifications, and that numerous variations of the invention may be employed, used and made without departing from the scope and spirit of the invention.

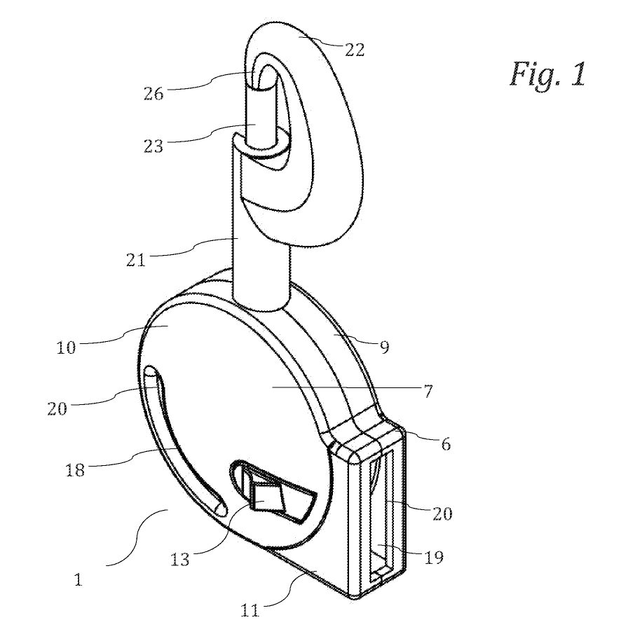

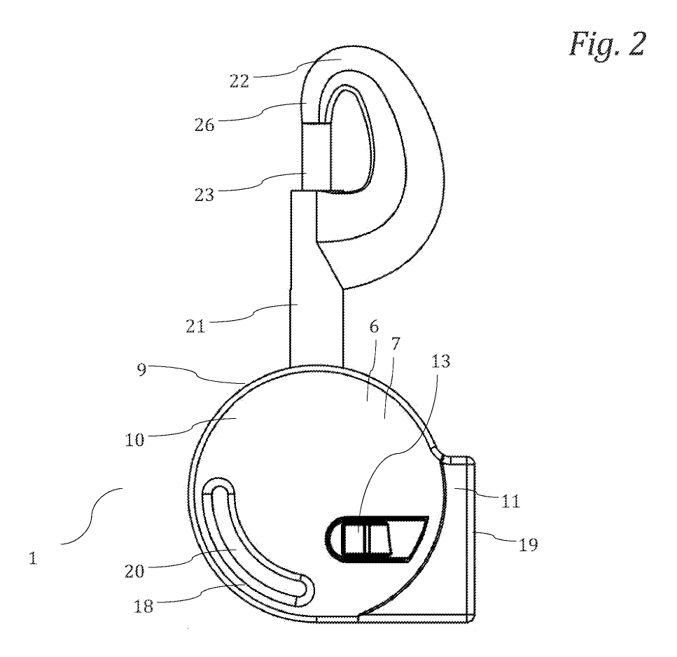

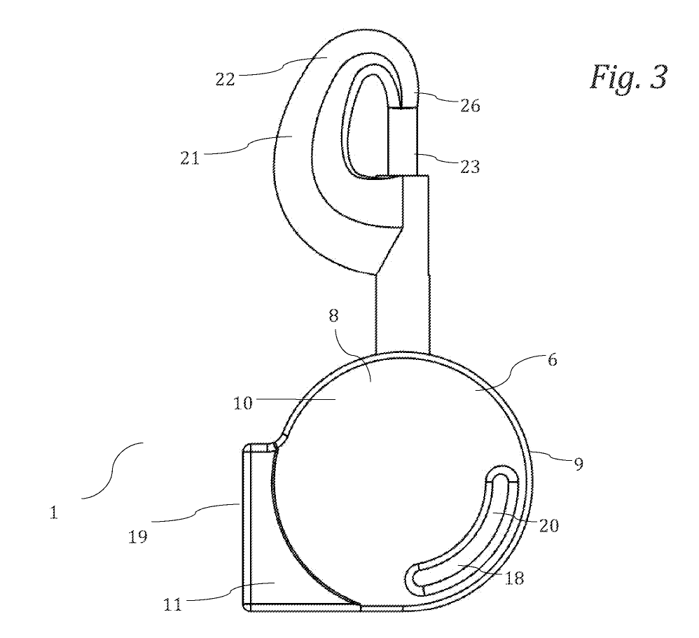

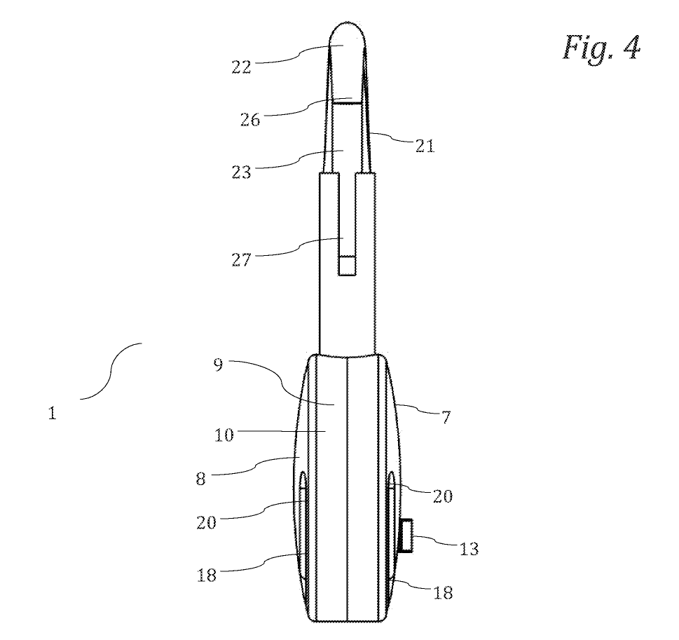

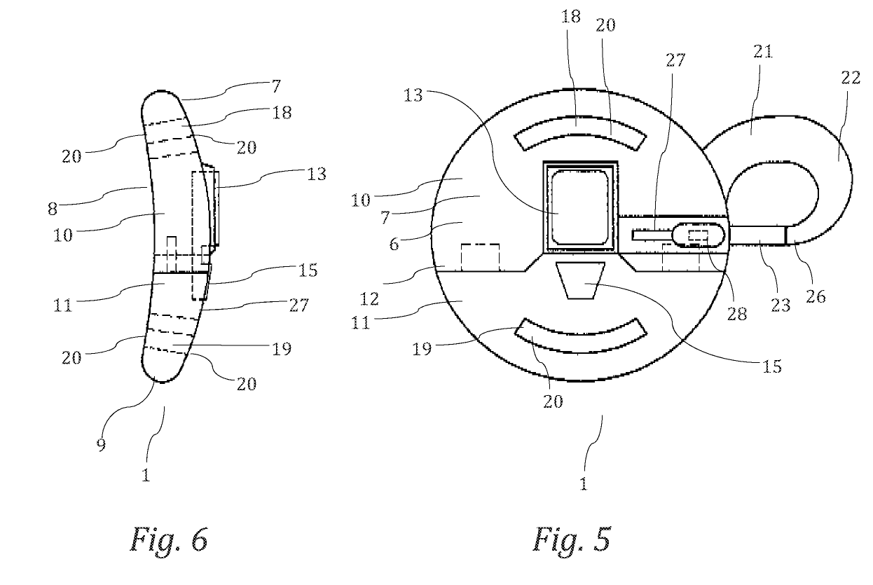

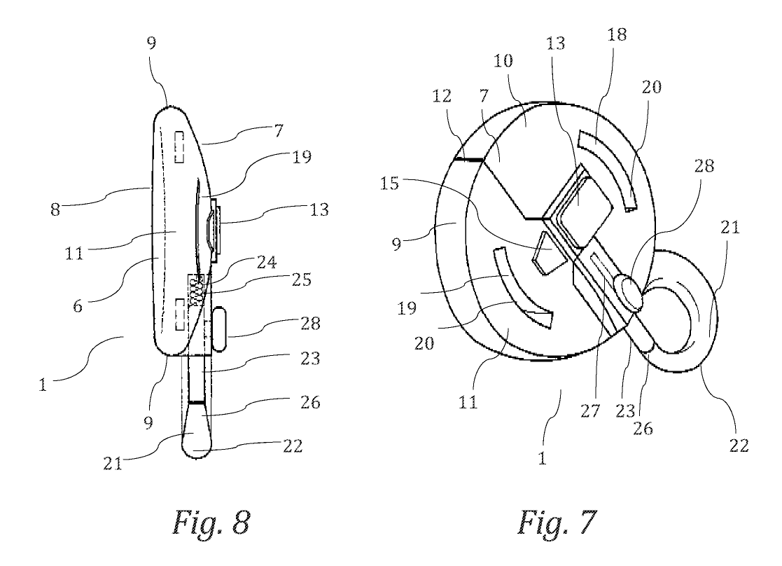

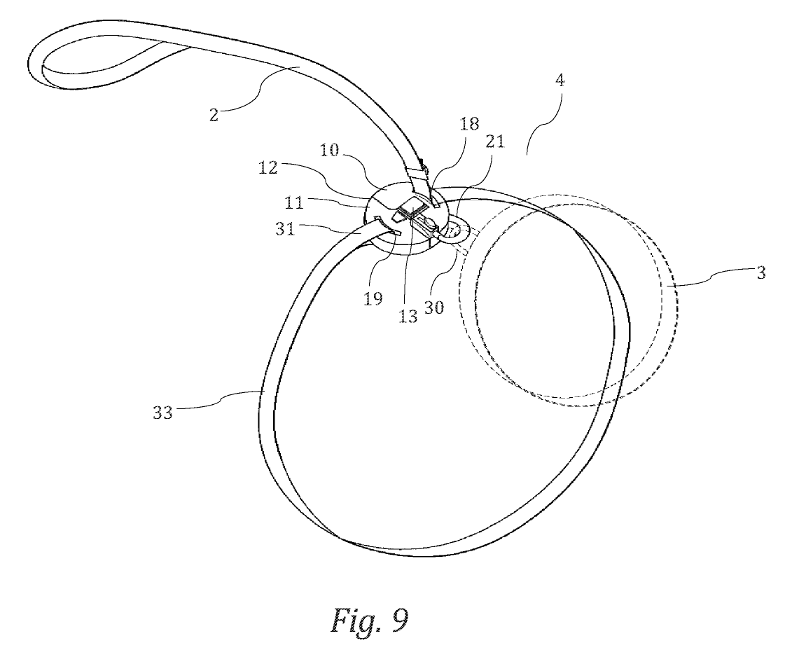

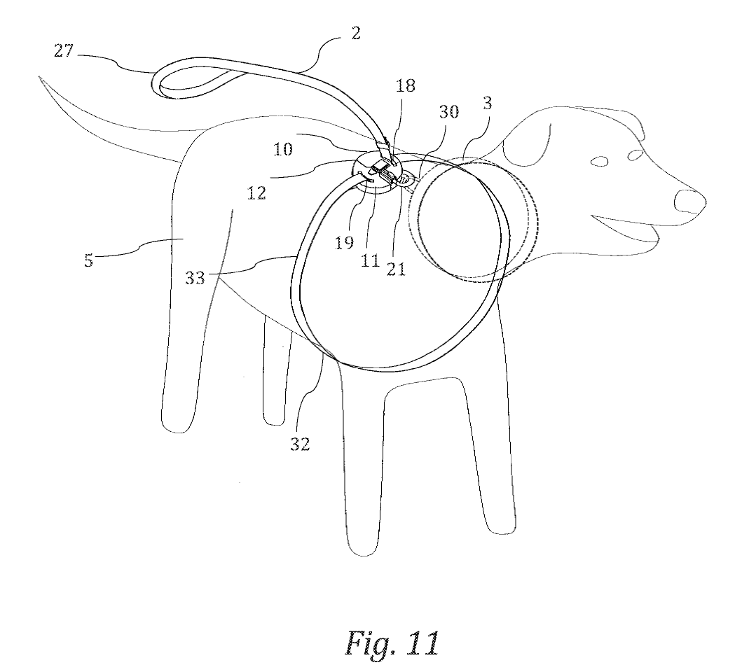

FIGS. 1-4 illustrate one embodiment of an apparatus 1 for removably coupling an animal leash 2 and an animal collar 3 to form a removable restraining assembly 4. FIGS. 5-11 illustrate another embodiment of the apparatus 1 for coupling an animal leash 2 and an animal collar 3 to form a removable restraining assembly 4 on an animal 5 (as illustrated in FIG. 11).

The apparatus 1 comprises a cylindrical housing 6 with a central axis, two sides 7 and 8 and a boundary component 9 separating the two sides 7 and 8. The sides 7 and 8 may be flat, concave or convex. The housing 6 may be any one of the following shapes, including but not limited to: cylinder, sphere, cube, cuboid, hexagon or octagon.

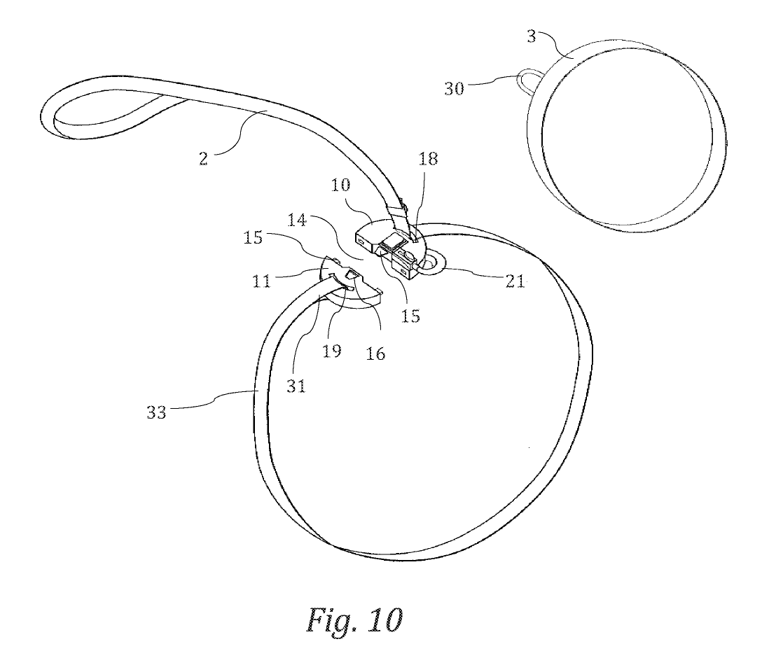

The housing 6 is composed of two separate portions 10 and 11 attached in a locked configuration 12. The housing 6 contains a user-actuated release mechanism 13 for separating portion 10 from portion 11 into the unlocked position 14 as shown in FIG. 10. In one embodiment, the user actuated release mechanism 13 may be one or more movable latches 15 on the portion 10 configured to interlock into one or more latching holes 16 on the portion 11 of the housing 6. These latches 15 may be movable out of the interlocking position with the press of a button 17. A compressed spring (not shown) may impel the latches 15 into interlocking position until user places pressure on the latch 15 to separate the housing portions 10 and 11.

Each portion 10 and 11 of the housing 6 contains a channel 18 and 19, respectively, that traverses each portion 10 and 11 with openings 20 on both sides 7 and 8 of the housing 6. The embodiment of the apparatus of FIGS. 1-4 illustrates channels 18 and 19 with non-complementary shapes. The embodiment of the apparatus of FIGS. 5-11 illustrates channels 18 and 19 with complementary shapes that are substantially parallel with one another and the boundary component 9. The channels 18 and 19 are elongated and narrow to slidably receive a wide flat leash 2. This channel configuration prevents the contained leash 2 from turning or becoming tangled in the apparatus 1. This channel configuration also retains a contained leash 2 in substantial alignment with the central axis of the housing 6.

The housing 6 further contains an integrated connector 21, which may be a bolt snap 21. The bolt snap 21 is attached to the housing 6 along the boundary component 9 and extends away from the housing 6 to a distal end retaining body 22. The bolt snap 21 is shaped like a question mark and contains a movable bolt 23 within an internal bore 24. A coil spring 25 within this internal bore 24 impels the movable bolt 23 towards the curved end area 26 of the retaining body 22 in the closed position. A long narrow slot 27 along the internal bore 24 contains an actuating member 28 that is attached to the movable bolt 23. The actuating member 28 is manually moved down the slot 27 compressing the coil spring 25 such that the bolt 23 no longer contacts the curved end area 26 of the retaining body 22 in the open position.

As illustrated in FIG. 11, the apparatus 1 is placed on the back of an animal 5, such that the end 22 of the connector or bolt snap 21 is near a neck-mounted collar 3. The bolt snap 21 is moved into the open position with the actuating member 28 and attached to a ring 30 on the collar 3. The bolt snap 21 is the allowed to close by releasing the actuating member 28. The non-handle end 31 of a wide, flat leash 2 is inserted through the one of the channels 18 on the housing 6. The leash 2 is the wrapped onto the abdomen 32 of the animal 5 and encircled around the torso behind the forelegs. The leash 2 is then inserted through the other channel 19 on the housing 6 to form a complete loop 33 around the animal 5. The non-handle end 31 of the leash 2 is then re-attached to itself. The elongate and narrow shape of the channels 10 and 11 prevents the contained leash 2 from turning or becoming tangled in the apparatus 1 or around the animal 5.

The apparatus 1 may be easily removed by pressing the user-actuated release button 13 to separate the two portions 10 and 11 of the housing 6. Once the unlocked housing portions 10 and 11 are separated, the circular loop 33 formed by the leash 2 is broken. Once the bolt snap 21 is also released from the collar 3, the leash 2 and the apparatus 1 may be removed from the animal 5. The leash 2 may remain attached to the apparatus 1, through the channels 18 and 19, to allow a user to easily re-attach the looped leash 33 to the animal 5.

In embodiments of the subject invention, the leash 2 is preferably a not a cord or chain leash, but a flat strap leash composed of non-metallic materials, such as nylon or leather.

The many aspects and benefits of the invention are apparent from the detailed description, and thus, it is intended for the following claims to cover such aspects and benefits of the invention, which fall within the scope, and spirit of the invention. In addition, because numerous modifications and variations will be obvious and readily occur to those skilled in the art, the claims should not be construed to limit the invention to the exact construction and operation illustrated and described herein. Accordingly, all suitable modifications and equivalents should be understood to fall within the scope of the invention as claimed herein.

What is claimed is:

1. An animal restraining apparatus for removably coupling an animal leash and an animal collar; the apparatus comprising:
a housing comprising a central axis defined by a first portion removably attached to a second portion, and further defined by a first side and a second side, wherein the first side and the second side are separated by a boundary component;
a first connector extending along a first axis from a proximal end attached to the housing to a distal end, wherein the first axis is substantially perpendicular to the central axis;
wherein the apparatus is mounted on the back of the animal such that the distal end of the first connector is proximate to the neck of the animal, further wherein a distal end of the leash is inserted through a first channel traversing the first portion of the housing, wrapped onto the abdomen of the animal, inserted through a second channel traversing the second portion of the housing, and re-attached to a non-distal end portion of the animal leash to define a loop encircling the torso of the animal, wherein the distal end of the first connector removably attaches to a second connector mounted on the animal collar; and
a user-actuated release mechanism on the housing that separates the first portion of the housing from the second portion of the housing for removing the looped leash from the animal.

2. The animal restraining apparatus of claim 1, wherein the housing comprises a shape that is selected from the group consisting of substantially cylindrical, spherical, cube, cuboid, hexagonal prism, and octagonal prism.

3. The animal restraining apparatus of claim 1, wherein the housing comprises a cross-sectional shape traverse to the central axis that is selected from the group consisting of substantially circular, elliptical, square, triangular, hexagonal and octagonal.

4. The animal restraining apparatus of claim 1, wherein the first connector is a bolt snap.

5. The animal restraining apparatus of claim 1, wherein the second connector on collar is a ring secured thereto.

6. The animal restraining apparatus of claim 1, wherein the leash is a wide flat leash.

7. The animal restraining apparatus of claim 1, wherein the leash is a strap lease.

8. The animal restraining apparatus of claim 1, wherein the leash is a composed of non-metallic materials.

9. The animal restraining apparatus of claim 1, wherein the user actuated release mechanism is a movable latch on the first portion configured to lock into a latching hole on the second portion.

10. The animal restraining apparatus of claim 1, wherein user actuated release mechanism comprises a spring-action latch release button.

11. The animal restraining apparatus of claim 1, wherein the first channel and the second channel comprise complementary shapes with each other.

12. The animal restraining apparatus of claim 1, wherein the first channel and the second channel comprise non-complementary shapes on the housing.

13. The animal restraining apparatus of claim 1, wherein the first channel and the second channel are both substantially parallel with the boundary component of the housing.

14. The animal restraining apparatus of claim 1, wherein the first channel and the second channel are each configured to hold the leash such that the leash cannot turn in the apparatus.

15. The animal restraining apparatus of claim 1, wherein the first channel and the second channel are each configured to slidably receive the animal leash such that a wide flat surface of the animal leash remains substantially aligned with the central axis as it is inserted.

16. The animal restraining apparatus of claim 1, wherein the first channel and the second channel each comprise an elongated narrow shape.

17. The animal restraining apparatus of claim 1, wherein the boundary component comprises an exterior surface that is substantially parallel with the central axis.

18. The animal restraining apparatus of claim 1, wherein the first side and the second side of the housing are substantially flat.

19. The animal restraining apparatus of claim 1, wherein the first side and the second side of the housing are substantially coplanar.

20. The animal restraining apparatus of claim 1, wherein the first side and the second side of the housing are substantially perpendicular to the central axis.
